(19) United States
(12) Patent Application Publication
(10) Pub. No.: US 2011/0299098 A1
(43) Pub. Date: Dec. 8, 2011

(54) Method and device for measuring coating amount, method and device for determining coating amount, coating device and method for manufacturing coating product

(75) Inventor: Norifumi Furuya, Tokyo (JP)

(73) Assignee: Toppan Printing Co., Ltd., Tokyo (JP)

(21) Appl. No.: 13/199,015

(22) Filed: Aug. 16, 2011

Related U.S. Application Data
(63) Continuation of application No. PCT/JP2010/063106, filed on Aug. 3, 2010.

(30) Foreign Application Priority Data
Aug. 31, 2009 (JP) 2009-200188
Mar. 10, 2010 (JP) 2010-052869

(51) Int. Cl. G01B 11/06

(52) U.S. Cl. 356/632

(57) ABSTRACT

One embodiment of the present invention is a method for measuring a coating amount in the case where a microcapsule coating liquid including a microcapsule in which a pigment is encapsulated and dispersed is coated on a microcapsule coating substrate, the method including steps of: detecting a transmission light intensity in the case where the microcapsule coating substrate on which the microcapsule coating liquid is in a wet state is irradiated with illuminating light; and calculating a thickness of a microcapsule display layer from the transmission light intensity, the microcapsule display layer formed by drying the microcapsule coating liquid.

### CROSS REFERENCE TO RELATED APPLICATION

This application is a continuation of International Application No. PCT/JP2010/063106, filed on Aug. 3, 2010, the entire contents of which are incorporated herein by reference.

### BACKGROUND OF THE INVENTION

1. Field of the Invention

The present invention is related to a method and a device for measuring a coating amount in which a coating amount of a microcapsule coating liquid is measured, a method and a device for determining a coating amount, a coating device, and a method for manufacturing a coating product. The present invention is related to coating of a microcapsule coating liquid in one process for manufacturing an electrophoresis front plate which is a main component of an electronic paper display.

2. Description of the Related Art

The development of various types of technology for realizing an electronic paper display having characteristics such as a high visibility, a rewritable property and low power consumption is advancing.

A display utilizing an electrophoresis phenomenon utilizes a phenomenon in which an electrically charged particle moves in a solvent due to an electric field. A microcapsule type electrophoresis type is realized as one technology among the various types.

A white particle and a black particle, the particles charged positively and negatively, are included in a microcapsule which is filled with a transparent liquid. When an exterior voltage is applied, the respective particles are raised so as to form an image. In this case, a diameter Φ of the microcapsule is as small as several tens of μm˜several hundred μm. Therefore, when this microcapsule is dispersed in a transparent binder liquid, it is possible to coat like an ink.

In addition, an electronic paper display tends to be low priced due to market competition. Thereby, a continuous production type roll-to-roll is adopted. In a roll-to-roll production method, a coating head such as a slot die coating head is used and an electronic ink is coated on a transparent substrate. This is described in patent document 1. In addition, in order to increase productivity, a coating head having a broad width is used, which is suitable for low cost by producing for a large area in one process.

On the other hand, patent document 2 proposes a method for calculating a coating amount in a dry state by measuring with a sensor of infrared light, as a method for measuring a wet state immediately after coating by a coater.

In addition, patent document 3 proposes a method for finding a coating amount from a relationship between a coating amount and a ray of transmission light when light is transmitted, as a method for measuring a thickness of a film of an absorption property, the film being formed on a transparent substrate.
patent document 1: JP-A-2002-526812
patent document 2: JP-A-H11-241912
patent document 3: JP-A-2009-53134

An ink in which a microcapsule is dispersed in a transparent binder liquid can be called an electronic ink because an image can be obtained when an exterior voltage is applied to the ink. This electronic ink is coated on a transparent substrate on which a transparent electrode layer is formed and thereby a component which is called a front plate is formed. Thereafter, when the front plate is attached to a substrate on which an electrode circuit for an active matrix driving is formed, an active matrix display panel can be formed. Therefore, a front plate of an electronic paper is largely influenced by a state of coating of an electronic ink.

Especially, in an electronic paper having the structure explained above, color is displayed by a white particle and a black particle which are encapsulated inside a microcapsule in an electronic ink. Therefore, if a microcapsule is non-uniformly coated on a transparent substrate, when a panel is formed, color influenced by the non-uniformity is displayed.

Therefore, after coating, a sample is cut out, an amount of a microcapsule which is coated per unit area is measured and it is necessary to confirm whether a specified coating amount has been coated. Therefore, in order to produce a non-defective product, a very large amount of loss is generated. Thus, a physical and quantitative method is needed, in which it is possible to nondestructively measure a coating amount per a unit area of a dry state when an electronic ink immediately after coating is in a wet state.

Here, in the case where a method shown in patent document 2 is applied to the coating of a microcapsule, a reflection state of an infrared light differs according to a dispersion state of a white particle and a black particle which are dispersed in a microcapsule. Therefore, even if a coating amount is identical, different results are obtained.

In addition, in the case where a method shown in patent document 3 is applied to the coating of a microcapsule, a final absorbed amount is different from a transmission absorbed amount due to a dry state. In particular, when optical characteristics change from a wet state to a dry state, an amount is measured during this change. Thereby, it is difficult to find an accurate coating amount.

### SUMMARY OF THE INVENTION

The present invention is made in light of the above problems. The purpose of the present invention is to provide a method and a device for measuring a coating amount, a method and a device for determining a coating amount, a coating device, and a method for manufacturing a coating product, in which a coating amount of a microcapsule coating liquid including a microcapsule in which a pigment is dispersed and encapsulated can be accurately measured.

In order to solve the above problems, a first aspect of the present invention is a method for measuring a coating amount in the case where a microcapsule coating liquid is coated on a microcapsule coating substrate, the microcapsule coating liquid including a microcapsule in which a pigment is encapsulated and dispersed,
the method including steps of:
   detecting a transmission light intensity in the case where the microcapsule coating substrate on which the microcapsule coating liquid is in a wet state is irradiated with illuminating light; and
   calculating a thickness of a microcapsule display layer from the transmission light intensity, the microcapsule display layer being formed by drying the microcapsule coating liquid.

In addition, a second aspect of the present invention is the method for measuring a coating amount according to the first aspect,
wherein the step of detecting the transmission light intensity includes individually detecting transmission light intensities in the case where three or more points including an end part and a center of the microcapsule coating substrate on which the microcapsule coating liquid is in a wet state are irradiated with illuminating light.

In addition, a third aspect of the present invention is the method for measuring a coating amount according to the first aspect,
wherein, in the step of detecting the transmission light intensity, a direct light intensity of the illuminating light is detected by irradiating the microcapsule coating substrate with illuminating light, and a change of illuminating light is offset using values of the transmission light intensity detected and the direct light intensity.

In addition, a fourth aspect of the present invention is a device for measuring a coating amount in the case where a microcapsule coating liquid is coated on a microcapsule coating substrate, the microcapsule coating liquid including a microcapsule in which a pigment is encapsulated and dispersed,
the device including:
   a means for irradiating, with illuminating light, the microcapsule coating substrate on which the microcapsule coating liquid is in a wet state;
   a means for detecting an intensity of transmission light which is obtained by illuminating light passing the microcapsule coating liquid in a wet state and the microcapsule coating substrate; and
   a means for calculating a thickness of a microcapsule display layer based on the intensity of the transmission light which is detected by the means for detecting the intensity of the transmission light, the microcapsule display layer to be formed by drying the microcapsule coating liquid.

In addition, a fifth aspect of the present invention is the device for measuring a coating amount according to the fourth aspect,
wherein the means for detecting the intensity of the transmission light is arranged at three or more positions including an end part and a center of the microcapsule coating substrate.

In addition, a sixth aspect of the present invention is the device for measuring a coating amount according to the fourth aspect,
further including:
a means for detecting direct light which individually detects direct light intensity of the illuminating light,
wherein, the means for calculating a thickness is configured to calculate a coating amount in a wet state based on the intensity of the transmission light detected by the means for detecting the intensity of transmission light, and is configured to calculate a coating amount of the microcapsule coating liquid by compensating for a change in the illuminating light based on values of the intensity of the transmission light which is detected and the direct light intensity.

In addition, a seventh aspect of the present invention is a method for determining a coating amount wherein a determination is made whether a thickness of a microcapsule display layer is within a predetermined range, the microcapsule display layer being in a dry state after drying a microcapsule coating liquid coated on a microcapsule coating substrate, the microcapsule coating liquid including a microcapsule in which a pigment is encapsulated and dispersed,
the method including steps of:
   finding a correlative relationship between an intensity of transmission light of the microcapsule coating substrate on which the microcapsule coating liquid in a wet state is coated and an actual thickness of the microcapsule display layer formed by drying the microcapsule coating liquid;
determining an appropriate range of a transmission light intensity of the microcapsule coating substrate on which the microcapsule coating liquid in the wet state is coated, the appropriate range of the transmission light intensity corresponding to a predetermined appropriate range of a thickness of the microcapsule display layer, the appropriate range determined as a standard range from the correlative relationship;
   detecting a transmission light intensity obtained by irradiating the microcapsule coating substrate in a wet state in which the microcapsule coating liquid is coated and is not dried with illuminating light; and
   determining the thickness of the microcapsule display layer as being an appropriate value in the case where the transmission light intensity is within the standard range when the transmission light intensity is compared with the standard range, or a non-appropriate value in the case where the transmission light intensity is not within the standard range when the transmission light intensity is compared with the standard range.

In addition, an eighth aspect of the present invention is the method for determining a coating amount according to the seventh aspect,
wherein the step of detecting the transmission light intensity includes individually detecting transmission light intensities in cases where three or more points including an end part and a center of the microcapsule coating substrate in which the microcapsule coating liquid is in a wet state are irradiated with illuminating light.

In addition, a ninth aspect of the present invention is the method for determining a coating amount according to the seventh aspect,
wherein, a direct light intensity of the illuminating light is detected in the step of detecting a transmission intensity,
and
wherein, in the step of determining the thickness of the microcapsule display, a change in the illuminating light is offset using values of the transmission light intensity detected and the direct light intensity.

A device for determining a coating amount wherein a determination is made whether a thickness of a microcapsule display layer is within a predetermined rang, the microcapsule display layer being in a dry state after drying a microcapsule coating liquid coated on a microcapsule coating substrate, the microcapsule coating liquid including a microcapsule in which a pigment is encapsulated and dispersed,
the device including:
a means for storing that contains a correlative relationship between an intensity of transmission light of the microcapsule coating substrate on which the microcapsule coating liquid in a wet state is coated and an actual thickness of a microcapsule display layer which is formed by drying the microcapsule coating liquid which is coated, wherein the means for storing stores, as a standard range from the correlative relationship, an appropriate range of a transmission light intensity of the microcapsule coating substrate on which the microcapsule coating liquid in the wet state is coated, the appropriate range of the transmission light intensity corresponding to a predetermined appropriate range of a thickness of the microcapsule display layer;
   a means for illuminating which irradiates, with illuminating light, the microcapsule coating substrate on which the microcapsule coating liquid is coated in a wet state;
   a means for detecting a light intensity which detects an intensity of transmission light of the illuminating light of the means for illuminating, the illuminating light passing through the microcapsule coating substrate on which the microcapsule coating liquid is coated; and
   a means for determining in which the intensity of the transmission light is compared with the standard range, and in which the thickness of the microcapsule display layer is determined as an appropriate value in the case where the intensity of the transmission light is within the standard range or a non-appropriate value in the case where the intensity of the transmission light is not within the standard range.

In addition, an eleventh aspect of the present invention is the device for determining a coating amount according to the tenth aspect,

wherein the means for detecting light intensity is arranged at three or more points including an end part and a center of the microcapsule coating substrate.

In addition, a twelfth aspect of the present invention is the device for determining a coating amount according to the tenth aspect,
further including:
a means for detecting direct light which individually detects a direct light intensity of the illuminating light,
wherein, in the means for determining, the determining includes offsetting a change in the illuminating light by using values of the intensity of the transmission light detected and the direct light intensity.

In addition, a thirteenth aspect of the present invention is a device for coating,
the device comprising:
the device for measuring a coating amount according to the fourth aspect,
wherein the microcapsule display layer is formed after coating and drying the microcapsule coating liquid to a dry state, the microcapsule coating liquid including a microcapsule in which a pigment is encapsulated and dispersed on the microcapsule coating substrate.

In addition, a fourteenth aspect of the present invention is a device for coating,
the device including:
the device for determining a coating amount according to the tenth aspect,
wherein the microcapsule display layer is formed after coating and drying the microcapsule coating liquid to a dry state, the microcapsule coating liquid including a microcapsule in which a pigment is encapsulated and dispersed on the microcapsule coating substrate.

In addition, a fifth aspect of the present invention is a method for manufacturing a coating product,
the method including:
the method for measuring a coating amount according to the first aspect,
wherein the microcapsule display layer is formed after coating and drying the microcapsule coating liquid to a dry state, the microcapsule coating liquid including a microcapsule in which a pigment is encapsulated and dispersed on the microcapsule coating substrate.

In addition, a sixteenth aspect of the present invention is a method for manufacturing a coating product,
the method including:
the method for determining a coating amount according to the seventh aspect,
wherein the microcapsule display layer is formed after coating and drying the microcapsule coating liquid to a dry state, the microcapsule coating liquid including a microcapsule in which a pigment is encapsulated and dispersed on the microcapsule coating substrate.

According to a method and a device for measuring a coating amount, a method and a device for determining a coating amount, a coating device, and a method for manufacturing a coating product related to the present invention, an operation is performed based on a correlation with a ray of light, the light passing through a coating amount of a microcapsule coating liquid when a transmission light illumination is used. Therefore, whatever the dispersion state of a white particle and a black particle inside a microcapsule, a correlation with an amount of a white particle and a black particle included in a microcapsule per unit area is high. As a result, a coating amount of a microcapsule coating liquid can be measured very accurately.

In addition, according to the present invention, a coating amount in a wet state immediately after coating can be nondestructively measured. Therefore, coating can be efficiently performed, it is possible to quickly check coating defects and reduce waste to a minimum when coating defects occurs.

In addition, according to the present invention, determining whether a microcapsule coating liquid which is coated on a microcapsule coating substrate is within a predetermined appropriate range of a coating amount is performed in-line and it is possible to check coating errors.

### BRIEF DESCRIPTION OF THE DRAWINGS

FIG. 1 is a diagram explaining a microcapsule used in a coating product of the present invention.

FIG. 2 is a diagram explaining a microcapsule coating liquid used in a coating product of the present invention.

FIG. 3 is a schematic cross sectional diagram of an electrophoresis type front plate which is to be a coating product of the present invention.

FIG. 4 is a diagram showing a structure of a coating device equipped with a method and a device for measuring a coating amount and a method and a device for determining a coating amount of a microcapsule related to the present invention.

FIG. 5 is a diagram showing a structure in the case where a coating amount of a microcapsule in a dry state is experimentally found from a transmission light intensity of the microcapsule coating substrate including a microcapsule coating liquid in a wet state in a device for coating a microcapsule related to the present invention.

FIG. 6 is a correlation diagram showing a correlative relationship between a transmission light intensity and a coating amount in a dry state in an embodiment of the present invention.

FIG. 7 is a correlation diagram showing a correlative relationship between a transmission light intensity in a wet state and a transmission light intensity in a dry state.

FIG. 8 is a diagram showing a change of a transmission light when a wet state becomes a dry state in an embodiment of the present invention.

FIG. 9 is a diagram explaining a distribution of a microcapsule film thickness on a substrate in an embodiment of the present invention.

FIG. 10 is a diagram explaining a distribution of a microcapsule film thickness on a substrate in an embodiment of the present invention.

FIG. 11 is a diagram of a structure of a coating device for adjusting a film thickness in an embodiment of the present invention.

FIG. 12 is a diagram explaining determining transverse unevenness in an embodiment of the present invention.

FIG. 13 is a diagram of a structure of a film thickness device in an embodiment of the present invention.

FIG. 14 is a diagram of a structure of a film thickness device in an embodiment of the present invention.

In these figures, 11 is a dispersion liquid; 12 is a white particle; 13 is a black particle; 14 is an electrophoresis microcapsule; 20 is a binder liquid; 25 is a transparent substrate; 26 is a transparent electrode; 27 is a display material (a microcapsule display layer); 31 is an illuminating part for a wet part; 33 is a light intensity detecting part for a wet part; 34 is a light intensity detecting part for a dry part; 35 is an operation part; 36 is a display part; 41 is a sending out master roll part; 42 is a coating part (a coating head); 43 is a drying unit; 44 is a winding master roll part; 45 is a microcapsule coating substrate; 46 is a storage part; 47 is a determining part; 48 is a roll; 49 is a stage; 51 is a direct light intensity detecting part; 52 is a power source; L is a measurement line; N1 is a transverse unevenness; and, N2 is a point defect.

### DETAILED DESCRIPTION OF THE INVENTION

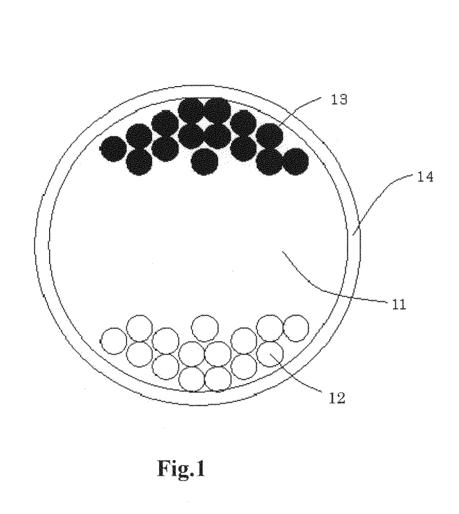

Hereinafter, embodiments of a method and a device for measuring a coating amount of a microcapsule, a method and a device for determining a coating amount, a coating device, and a method for manufacturing a coating product related to the present invention are explained while referring to FIGS. 1-4.

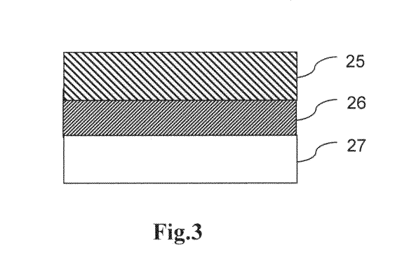

A coating product of the present invention is as follows. A transparent microcapsule coating liquid is coated on a transparent microcapsule coating substrate. The transparent microcapsule coating liquid includes a microcapsule in which a pigment is encapsulated and dispersed. The microcapsule coating liquid is dried and a microcapsule display layer is formed. Specifically, an electrophoresis type front plate is exemplified as a coating product. FIG. 3 shows a schematic cross sectional diagram of an electrophoresis type front plate which is a coating product of the present invention. This electrophoresis type front plate, as shown in FIG. 3, includes a transparent substrate 25, a transparent electrode 25, and a display material (which corresponds to a microcapsule display layer, hereinafter, called a microcapsule display layer) 27.

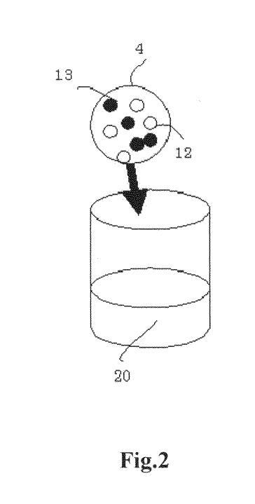

An electrophoresis microcapsule which is to be a microcapsule display layer 27 is a microcapsule shell in which a dispersion liquid and a colored pigment are encapsulated and dispersed. FIG. 1 shows a diagram explaining a microcapsule used for a coating product of the present invention. In addition, FIG. 2 shows a diagram explaining a microcapsule coating liquid used for a coating product of the present invention.

An electrophoresis capsule is, for example, manufactured as follows. A dispersion liquid is prepared as follows. A white particle and a black particle are respectively dispersed in a tetrachloroethylene solvent. The white particle is comprised of titanic oxide having an average particle diameter of 3 μm and its surface is covered with a polyethylene resin and is negatively-charged in a solution. The black particle (Pigment black) (13Bk) is subjected to a surface treatment using alkyl trimethylammonium chloride (R(CH₃)₃N⁺Cl⁻, R is alkyl group), and is positively-charged in a solution.

The respective dispersion liquids are respectively mixed with a water solution in which a water of 40 degrees Celsius includes gelatin and sodium dodecyl sulfate as an emulsifying agent. The mixed solutions are kept at 40 degrees Celsius while the mixed solutions are respectively stirred using a homogenizer, and thereby an 0/W (oil in water) emulsion is obtained.

Next, the obtained 0/W emulsion is mixed with a water solution in which water of 40 degrees Celsius includes gum Arabic, using a dispersion mixer. While the mixed solution is kept at 40 degrees Celsius, the pH of the mixed solution is adjusted using acetic acid, and a microcapsule shell 14 shown in FIG. 1 is formed by coacervation.

Further, each liquid temperature is adjusted to be 5 degrees Celsius, a formalin solution is added and the pH of the solution is adjusted using sodium hydrate. Then, the liquid temperature is adjusted to 50 degrees Celsius while the solution is stirred, and thereby a microcapsule shell is cured. A diameter of a microcapsule in which a dispersion liquid 11 with dispersed white particle 12 or black particle 13 is encapsulated is uniformed to 40 μm by a sieving treatment.

Thereafter, as shown in FIG. 2, the obtained electrophoresis microcapsule is mixed with a polyurethane resin solution (Nippolan 5037, a product of Nippon Polyurethane Industry Co., Ltd.) and thereby an electrophoresis microcapsule coating liquid (an electronic ink) is prepared. The microcapsule coating liquid obtained in this way is applied to a transparent electrode on a transparent substrate and dried, and thereby a microcapsule layer which is a coating product is formed.

Glass and plastic (styrene resin, cellulose, cresol resin, epoxy resin, melamine resin, polyamide, polycarbonate, polyethylen, acrylic resin, phenol resin, polyisobutylene, methacrylic resin, acetal resin, polypropylene, polystyrene, ethylene resin, polyurethane, vinyl resin, poval, vinylidene resin, silicone resin, urea resin, polyester resin, fluorine resin, cycloolefin polymer) are used as a transparent substrate 25 having electric insulating properties. However, a transparent substrate 25 is not limited to these.

A transparent electrode 26 is comprised of a transparent conductive film. Tin oxide, indium oxide, zinc oxide, conductive polymer and the like can be used. A transparent conductive film is formed on a surface of a substrate by a well known method such as evaporation, sputtering, electrodeposition, coating and printing.

In the case where an electrophoresis type front plate of a coating product is formed, the transparent electrode 26 is formed on one side surface of the transparent substrate 25. Next, an electrophoresis microcapsule coating liquid which becomes a microcapsule display layer 27 is applied to a transparent electrode so that a microcapsule is arranged inside one layer. Further, a protective film is attached to an opposite surface of the microcapsule display layer 27 to the transparent electrode. An electrophoresis front plate from which a protective film is peeled is attached to a rear substrate with a pixel electrode, and thereby an electrophoresis display device can be manufactured.

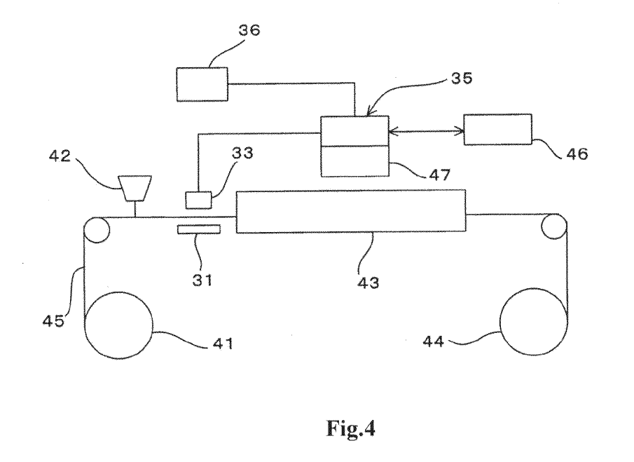

Next, a structure of a coating device which uses a method for measuring a coating amount of a microcapsule and a method for determining a coating amount of a microcapsule related to the present invention is explained using FIG. 4. FIG. 4 is a structural figure of a coating device equipped with a method and a device for measuring a coating amount and a method and a device for determining a coating amount of a microcapsule related to the present invention.

In FIG. 4, a coating device coats a microcapsule coating liquid on a transparent microcapsule coating substrate 45 through (not illustrated) a transparent electrode layer, the microcapsule coating liquid formed by mixing a microcapsule and a binder liquid, the microcapsule having dispersed white particles and black particles for an electronic paper display. The coating device is comprised of a master roll dispenser part 41, a coating part 42, a drying unit 43, a winding master roll part 44 and a device for measuring a coating amount having a means for determining a coating amount.

The master roll dispenser part 41 dispenses a microcapsule coating substrate 45 on which a microcapsule coating liquid is not coated yet. The coating part 42 coats a microcapsule coating liquid on the microcapsule coating substrate 45 dispensed from the master roll dispenser part 41 through (not illustrated) a transparent electrode layer.

A coating thickness is determined for example by obtaining a color of sufficient black or white, the ability to drive a pigment inside a microcapsule using low electric power, and in a dry state, a film thickness is equal to or more than 5 μmwhich is the diameter of a small microcapsule, and is equal to or less than 40 μm which is the diameter of a standard microcapsule cell.

A drying unit 43 dries a microcapsule coating liquid which is coated on the microcapsule coating substrate 45 through (not illustrated) a transparent electrode layer. The drying unit 43 is arranged between the master roll dispenser part 41 and the master roll winding part 44. The drying unit 43 dries a microcapsule coating liquid which is coated on the microcapsule coating substrate 45 through (not illustrated) a transparent electrode layer.

The master roll winding part 44 winds a microcapsule coating substrate on which a microcapsule display layer which is a coating product is formed. A device for measuring a coating amount is comprised of an illuminating part for a wet part 31, a light intensity detecting part for a wet part 33, an operation part 35 (which corresponds to a storage means described in the scope of the patent claims), a display part 36, a storage part 46 (which corresponds to a calculating means described in the scope of the patent claims), and a determining part 47 (which corresponds to a determining means described in the scope of the patent claims).

The illuminating part for a wet part 31 transilluminates the microcapsule coating substrate 45 including a microcapsule coating liquid in a wet state. In addition, a light intensity detecting part for a wet part 33 detects intensity of light from the illuminating part for a wet part 31 which passes through the microcapsule coating substrate 45 coated with a microcapsule coating liquid in a wet state.

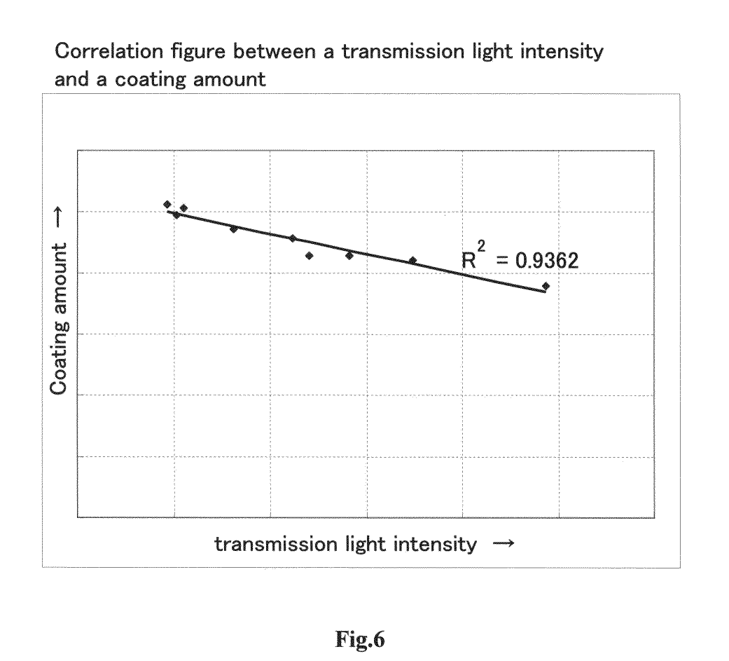

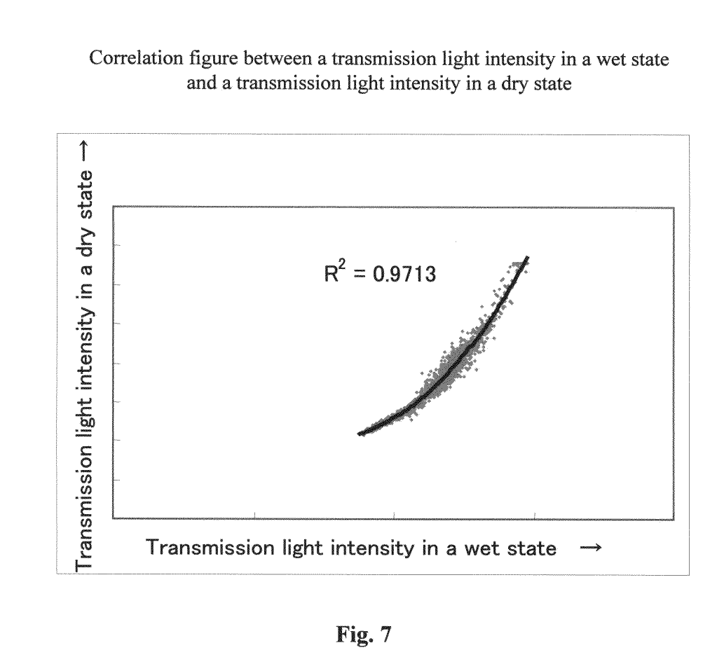

The storage part 46 stores a correlative relationship as correlation data, the correlative relationship being between a transmission light intensity of the microcapsule coating substrate 45 including a microcapsule coating liquid in a wet state and an actual thickness (a coating amount) of the microcapsule display layer 27 in a dry state which is formed by drying a microcapsule coating liquid. Specifically, the graphs shown in FIGS. 6 and 7 are converted into tables and are stored as correlation data. FIG. 6 is a correlation diagram showing a correlative relationship between a transmission light intensity in a dry state and a coating amount in an embodiment of the present invention. FIG. 7 is a correlation diagram showing a correlative relationship between a transmission light intensity in a wet state and a transmission light intensity in a dry state.

Further, the storage part 46 stores an appropriate range of a transmission light intensity as a standard range of the microcapsule coating substrate 45 coated with a microcapsule coating liquid in the wet state which corresponds to an appropriate range of a thickness of the microcapsule display layer 27 which is set beforehand in view of a correlative relationship between the transmission light intensity and an actual coating amount.

The operation part 35 calculates and finds a thickness of the microcapsule display layer 27 in a dry state, based on a transmission light intensity detected by the light intensity detecting part for a wet part 33 and correlative data stored in the storage part 46. Then, the display part 36 displays the thickness found by the operation part 35.

In addition, the determining part 47 compares a transmission light intensity detected by the light intensity detection part for a wet part 33 with the standard range stored in the storage part 46. In the case where a transmission light intensity is within the standard range, the thickness of the microcapsule display layer 27 is determined as an appropriate value. In the case where a transmission light intensity is not within the standard range, the thickness of the microcapsule display layer 27 is not determined as an appropriate value. The determining result is displayed in the display part 36.

In the present invention, a calculated thickness of a microcapsule display layer also includes a physical numerical value having a correlative relationship with a thickness of a microcapsule display layer. A physical numerical value is not limited as long as the physical numerical value has a correlative relationship with the thickness of the microcapsule display layer. Examples of the value include a transmission light intensity, a coating amount, and, hardness, transmittance and reflectance of a microcapsule layer.

In the present invention, a display part may display not only a thickness of a microcapsule display layer but also a physical numerical value having a correlative relationship with the thickness of the microcapsule display layer. In addition, in a determining part, determination may be performed based not only on a thickness of a microcapsule display layer but also on a physical numerical value having a correlative relationship with the thickness of the microcapsule display layer.

However, even in the case where a physical numerical, value having a correlative relationship is calculated, it is necessary that a correlative relationship between a transmission light intensity and a thickness of the microcapsule display layer 27 in a dry state is found beforehand as correlative data, the microcapsule display layer 27 being formed by drying the coated a microcapsule coating liquid.

In the present invention, not only a thickness in a dry state but also other physical numerical values can be a measured value as long as a correlative relationship between a transmission light intensity which is measured beforehand and an actual thickness of the microcapsule display layer 27 in a dry state is found as correlative data, the microcapsule display layer 27 being formed by drying a microcapsule coating liquid.

In addition, determination of an appropriate value can be performed based not only on a thickness in a wet state or a dry state but also on other physical numerical values as long as a correlative relationship with an actual thickness of the microcapsule display layer 27 in a dry state is found as correlative data beforehand, the microcapsule display layer 27 being formed by drying a microcapsule coating liquid.

According to a coating device using a method for measuring and determining a coating amount of a microcapsule in such an embodiment, an operation is performed using correlation with a ray of light transmitting through a coating amount of a microcapsule coating liquid using a transmission light illumination. Therefore, whatever the dispersion state of a white particle and a black particle, correlation with an amount of white particles and black particles is high and, as a result, a thickness of the microcapsule display layer 27 can be calculated very accurately.

In the case where a coating amount deviates from a standard range and a thickness of the microcapsule display layer 27 is not determined as an appropriate value, a coating condition of a coating part is quickly changed and thereby a coating amount can be within a standard range. At this time, a coating amount can be adjusted to be within a standard range without stopping the coating device.

According to the present embodiment, a thickness of the microcapsule display layer 27 in a wet state immediately after coating can be measured by a nondestructive method. Therefore, coating can be efficiently performed while manufacturing with little waste is possible by quickly detecting defects. In the case where a thickness of a microcapsule display layer in a wet state is not measured and only a thickness of a microcapsule display layer in a dry state is measured, when a coating amount of a microcapsule coating liquid deviates from a standard range, the microcapsule coating substrate 45 formed with a microcapsule and a transparent electrode layer corresponding to a length of a drying oven 43 is wasted. According to the present embodiment, manufacturing can be performed while such waste is minimized. In addition, according to the present embodiment, determining whether a microcapsule coating liquid coated on a microcapsule coating substrate is within a coating amount of a determined appropriate range can be performed.

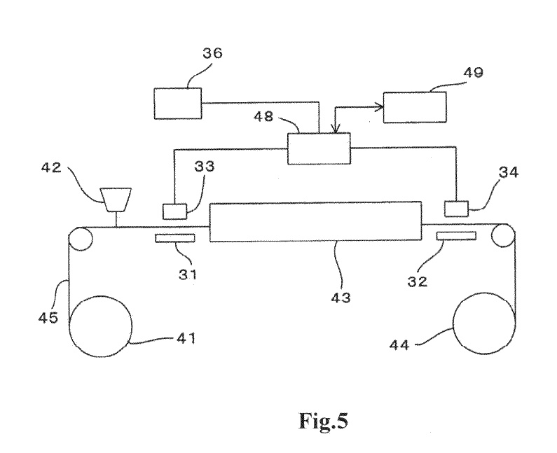

Next, the case where a coating amount of a microcapsule in a dry state is experimentally found under an in-line condition from a transmission light intensity in a wet state in a coating device of a microcapsule in the present invention is explained while referring to FIGS. 5-7.

FIG. 5 shows a structural diagram of a coating device in a case where, in a coating device of a microcapsule in the present invention, a coating amount of a microcapsule in a dry state is experimentally found from a transmission light intensity of the microcapsule coating substrate including a microcapsule coating liquid in a wet state. In FIG. 5, a coating device includes a master roll dispenser part 41, a coating part 42, a drying unit 43, a master roll winding part 44 and a means for calculating a coating amount in which a coating amount of a microcapsule of a dry state is experimentally calculated from a transmission light intensity of a wet state, the same as in FIG. 4.

The means for calculating a coating amount includes an illuminating part for a wet part 31, a illuminating part for a dry part 32, a light intensity detecting part for a wet part 33, a light intensity detecting part for a dry part 34, an operation processing part 48, a storage part 49 and the like.

The same as in FIG. 4, the illuminating part for a wet part 31 transilluminates a microcapsule coating substrate 45 including a microcapsule coating liquid in a wet state where a microcapsule coating liquid is not dried. The illuminating part for a dry part 32 transilluminates the microcapsule coating substrate 45 including a microcapsule coating layer in a dry state, the layer being dried by the drying unit 43.

The light intensity detecting part for a wet part 33 detects an intensity of light from the illuminating part for a wet part 31, the light being transmitted through the microcapsule coating substrate 45 which includes a microcapsule coating liquid in a wet state. In addition, the light intensity detecting part for a dry part 34 is used for finding a thickness of a microcapsule display layer 27 which is a coating amount in a dry state based on a transmission light intensity measured when a microcapsule coating liquid is coated and in a wet state. The light intensity detecting part 34 detects an intensity of light from the illuminating part for a dry part 32, the light being transmitted through the microcapsule coating substrate 45 on which a microcapsule coating layer is coated.

The operation processing part 48 calculates a difference between an intensity of transmission light detected by the light intensity detecting part for a wet part 33 and an intensity of a transmission light detected by the light intensity detecting part for a dry part 34. This intensity is added to a coating amount of a microcapsule coating liquid in a wet state and thereby a coating amount in a dry state is calculated. The calculated thickness (a coating amount) of the microcapsule display layer 27 in a dry state is associated with an intensity of transmission light detected by the light intensity detecting part for a wet part 33 and is stored in the storage part 49.

Specifically, the graphs shown in FIGS. 6 and 7 are converted into tables and the data (tables) are stored as correlative data. In addition, various data calculated by the operation processing part 48 are displayed on a display part 36.

In a device for measuring a coating amount shown in the present embodiment including such means for calculating a coating amount, whatever the dispersion state of a white particle and a black particle inside a microcapsule, a thickness of the microcapsule display layer 27 which is a coating amount is accurately measured.

In FIG. 6, a microcapsule coating liquid is coated on a transparent substrate as a thin film. Thereafter, a microcapsule coating liquid which is coated is dried by the drying unit 43. Thereafter, the substrate is cut and divided into a plurality of pieces each having an identical size. Each of the pieces has different coating amounts. FIG. 6 shows a relationship between a sample having a different coating amount and a transmission light intensity of the sample.

As is clear from FIG. 6, a pigment inside a microcapsule is in a random dispersion state. However, it is found that a transmission light intensity has a correlation with a coating amount without being influenced by the random state. A thickness of the microcapsule display layer 27 which is a coating amount can be found from a transmission light intensity.

In addition, a method for finding a coating amount in a dry state from a transmission light intensity of a wet state in the present invention is described below. The method is not limited to finding a thickness of the microcapsule display layer 27 which is a coating amount in a dry state based on correlation data which is converted into a table. A thickness of a microcapsule display layer which is a coating amount may be found from an experimental formula obtained based on approximated curves as shown in FIGS. 6 and 7, a proportional expression and an experimental formula based on the approximated curves, or, interpolation operation. Without using a coating device as shown in FIG. 5 in which an in-line measurement is possible, an appropriate range of a transmission light intensity of the microcapsule coating substrate 45 formed with a microcapsule coating liquid in a wet state may be found by finding a correlative relationship between a transmission light intensity in a wet state and a coating amount in a dry state by performing a different experiment.

In the present invention, using a device for measuring a coating amount, a microcapsule is coated on a transparent substrate and a coating product in which a microcapsule display layer is formed on a microcapsule coating substrate wherein a film thickness is controlled to be within a standard range is provided.

Next, a method is explained for determining a traverse unevenness which leads to improvements in productivity where a defective product is removed in order to stop subsequent processes because a non-defective product can not be partially obtained due to film thickness defects outside of standard thickness range entirely in a width direction when a device for measuring a film thickness of a microcapsule coating is used.

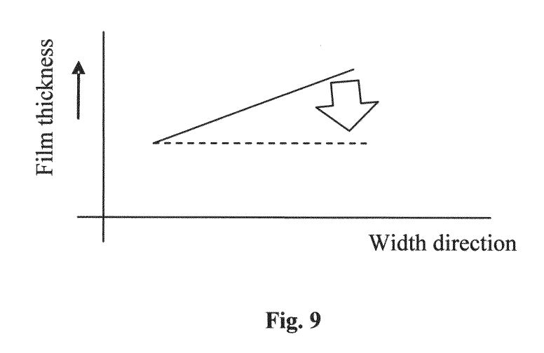

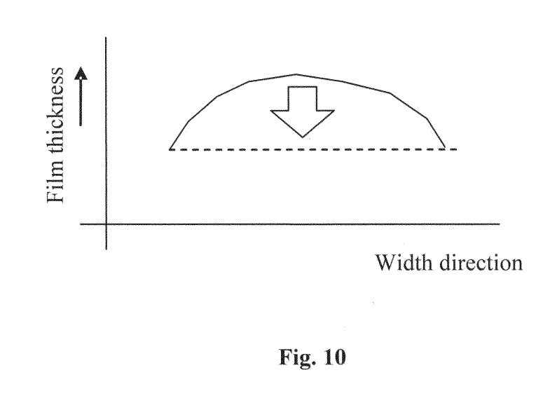

FIG. 9 is a diagram explaining a distribution of a film thickness of a microcapsule on a substrate in an embodiment of the present invention. In addition, FIG. 10 shows a diagram explaining a distribution of a film thickness of a microcapsule on a substrate in an embodiment of the present invention. In a case of a coating head having a narrow width, as shown in FIG. 9, only the right side or left side may be thicker. In a case of a coating head having a wide width, especially a wide width of more than 300 nm, only one side may be thicker the same as the case of a narrow coating head, or, as shown in FIG. 10, a film thickness at a center in a width direction may be thicker or thinner than an end part. Therefore, it is necessary to slightly adjust not only a right and left gap but also a center gap. Therefore, after coating, samples used for measurement are cut out, the samples being located at a plurality of positions in a width direction, coating amounts of three or more points including both ends and a center part with respect to a forward direction of a transparent substrate are measured, the gaps are required to be adjusted, significant losses (time loss, material loss) occur and if a film thickness does not fall within a standard range by one adjustment, it was necessary to repeat adjustment several times.

At least three or more points including end parts and a center part of the microcapsule coating substrate in a wet state are irradiated with illuminating light and the transmission light intensities are individually detected. Thereby, coating amounts of a microcapsule coating liquid including a microcapsule in which a pigment is dispersed and encapsulated are simultaneously measured at 3 or more points immediately after coating as coating amounts in a dry state, and it is possible to determine whether all the measured values at measured points are within an acceptable range.

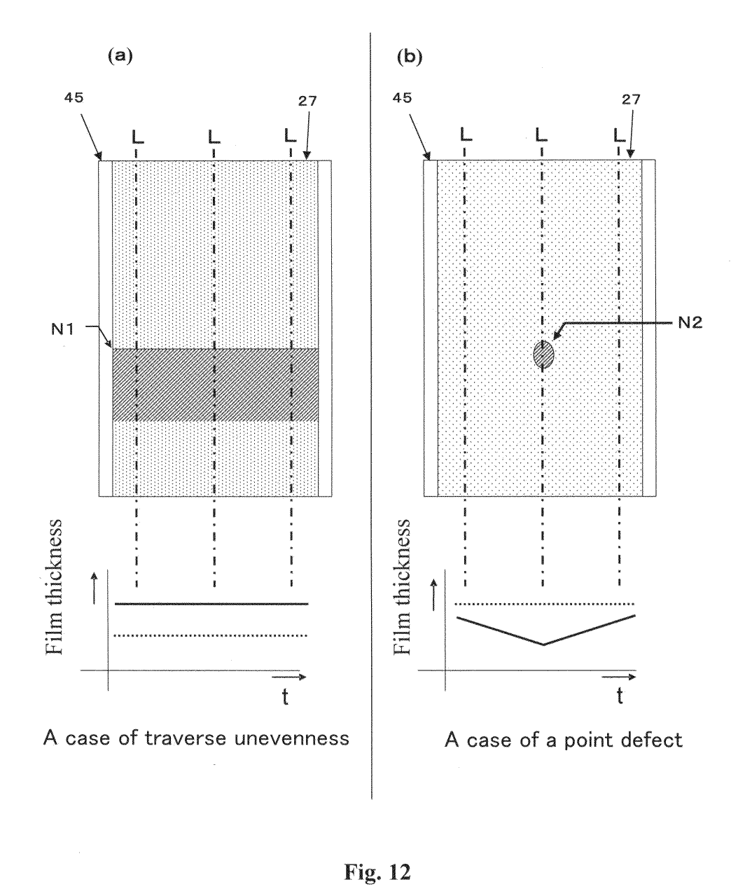

FIG. 12 shows a diagram explaining a determination of a traverse unevenness in an embodiment of the present invention. In FIG. 12, three points in a width direction of a microcapsule coating substrate are measured. FIG. 12(a) is a diagram explaining a traverse unevenness. FIG. 12(b) is a diagram explaining a point defect. As shown in FIG. 12(a), a traverse unevenness is a film thickness change phenomenon in which a change of concentration in a width direction of a transparent substrate occurs horizontally and thereafter a film thickness gradually returns to an original film thickness.

In the case where a film thickness can be measured at light intensity detection points of three or more in a width direction, for example, in the case where a point defect exists at a center part, only one light intensity detection part for a wet part detects a change in a film thickness and other light intensity detection parts do not detect change in a film thickness. In contrast, in the case of a traverse unevenness, unevenness in a film thickness exists entirely in a width direction and all light intensity detection parts for a wet part simultaneously detect change in a film thickness. It is possible to determine that traverse unevenness has occurred by calculating that simultaneous changes in a film thickness have occurred.

In addition, in the case where only one light intensity detection part detects a change in a film thickness and other light intensity detection parts do not detect a change, a point defect exists only at a part where change in a film thickness is detected. Therefore, it is also possible to determine an occurrence of a point defect.

Referring to FIG. 12, a coating amount is measured at three points including two end points and one center point in a width direction of a microcapsule coating substrate 45. This is shown by the three measurement lines L. In the case of a traverse unevenness N1 shown in FIG. 12(a), a film thickness at all points on the measurement lines L changes compared with a film thickness immediately before a traverse unevenness shown by a dotted line part in a lower figure. Thereby, determination of a traverse unevenness is possible. On the other hand, in the case of a point defect shown in FIG. 12(b), only a center part among measurement lines L changes compared with a film thickness immediately before a defect unevenness shown by a dotted line part in a lower figure. Thereby, determination of a point defect is possible.

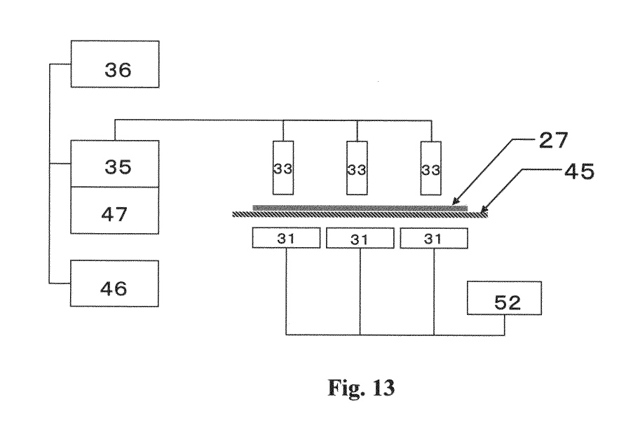

FIG. 13 shows a diagram of a film thickness device structure in an embodiment of the present invention. As shown in FIG. 13, a device for measuring a coating amount includes an illuminating part for a wet part 31 which is arranged at three or more positions including both ends and a center part in a width direction of a transparent substrate, a light intensity detecting part for a wet part 33 which is arranged so as to face the respective illuminating part for a wet part, an operating part (means for operating a coating amount) 35, a display part 36 and a storage part (means for storing) 46, a determining part (means for determining) 47 or the like.

The illuminating part for a wet part 31 performs transillumination to a microcapsule coating substrate 45 including a microcapsule coating liquid in a wet state. In addition, the light intensity detection part for a wet part 33 detects an intensity of light from the illuminating part for a wet part 31, the light passing through the microcapsule coating substrate 45 on which a microcapsule coating liquid in a wet state is coated.

The storage part 46 stores as correlative data the correlative relationship between a transmission light intensity of the microcapsule coating substrate 45 including a microcapsule coating liquid in a wet state and an actual thickness (a coating amount) of a microcapsule display layer 27 in a dry state which is formed by drying a microcapsule coating liquid.

In particular, data which is converted into a table from graphs shown in FIGS. 6 and 7 is stored as correlative data. Further, the storage part 46 stores an appropriate range of a transmission light intensity of the microcapsule coating substrate 45 on which a microcapsule coating liquid is coated in a wet state, as a standard range, the appropriate range of the transmission light intensity corresponding to a thickness of the microcapsule display layer 27 of an appropriate range which is determined beforehand from a correlative relationship between a transmission light intensity and an actual coating amount.

The operating part 35 calculates a thickness of the microcapsule display layer 27 in a dry state where a microcapsule coating liquid is coated and dried, based on respective transmission light intensities detected by the light intensity detection part for a wet part 33 and correlative data stored in the storage part 46. Further, the display part 36 displays a thickness (a coating amount) which is calculated by the operating part 35.

In addition, the determining part 47 compares a transmission light intensity detected by the light intensity detection part for a wet part 33 with a standard range stored in the storage part 46. If all of the transmission light intensities are within a standard range, it is determined that a thickness of the microcapsule display layer 27 is an appropriate value. If a transmission light intensity of any one position is not within a standard range, it is determined that a thickness of the microcapsule display layer 27 is not an appropriate value. Further, the result of the determination is displayed on the display part 36.

In a device for measuring a coating amount of a microcapsule in such an embodiment, an operation is performed based on a correlation with a ray of light which is transmitted through a coating amount of a microcapsule coating liquid, using a transmission light illumination. Therefore, whatever the state of dispersion of a white particle and a black particle includes in a microcapsule, the correlation between an amount of white particles and an amount of black particles included in a unit area of a microcapsule is high. As a result; a coating amount of a microcapsule coating liquid of three positions can be simultaneously and highly accurately measured.

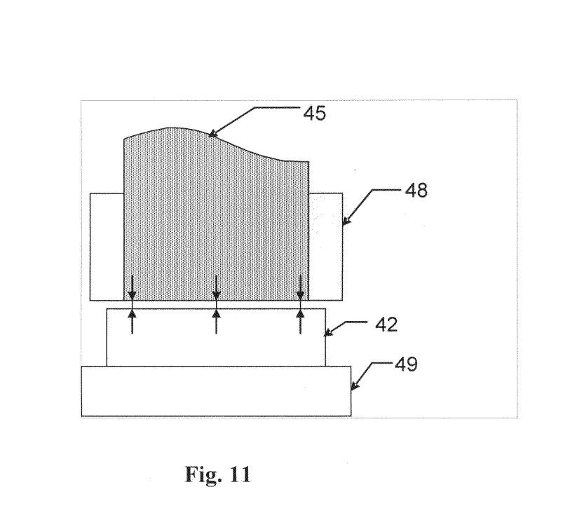

As a result, even if a distribution of a film thickness of a coated capsule as shown in FIGS. 9 and 10 deviates from a standard range, a gap between a coating head 42 and a roll 48 can be adjusted based on a value of film thickness shown by a display part, and a value of a film thickness entirely in a width direction can be adjusted within a standard range without stopping a device for coating. FIG. 11 shows a structural diagram of a coating device for adjusting a film thickness in an embodiment of the present invention. In FIG. 11, a running microcapsule coating device 45 passes roll 48. When the device 45 passes roll 48, a coating part 42 which is a coating head coats a microcapsule coating liquid. At this time, the coating head 42 is fixed to a stage 49. By adjusting the stage, a gap between the coating head and the roll 48 (a value of a film thickness entirely in a width direction) can be adjusted within a standard range.

In addition, according to a device for measuring a coating amount of a microcapsule in such an embodiment, it is possible to secure coating of an in-plane film at a constant film thickness based on the result of a determination as to whether the value is to be maintained within a predetermined standard range.

In addition, using this device for measuring a coating amount, a microcapsule is coated on a microcapsule coating substrate, and a coated product formed with a microcapsule display layer on the microcapsule coating substrate in which a film thickness in-plane of the microcapsule display layer is controlled to be within a standard range can be provided.

In addition, the number of measurement points in which a coating amount of a microcapsule coating liquid is measured is preferably large. However, it is preferable that at least three points including both ends and a center part in a width direction of a microcapsule coating substrate are measured.

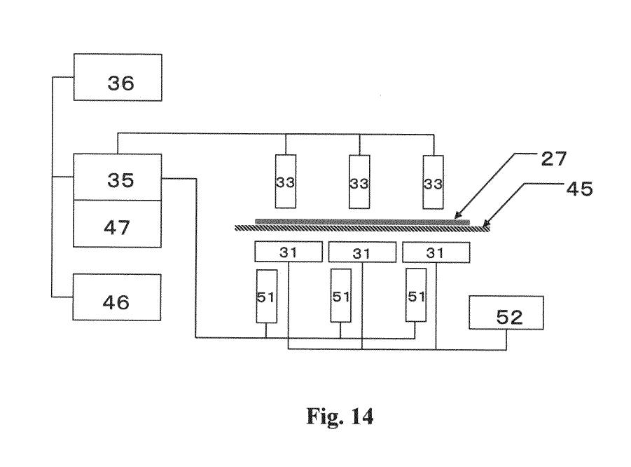

Next, a device for measuring a microcapsule coating film thickness which can secure the reliability of a film thickness value even in the case of a change in the amount of light due to decay of a ray of light of an illuminating part after prolonged use or a change in the amount of light due to a change in temperature of an illuminating part just after start-up, or instant change of a ray of light of an illuminating part due to exterior noise to a power source line is explained using FIG. 14. FIG. 14 shows a structural diagram of a device for measuring a film thickness in an embodiment of the present invention.

In the device shown in FIG. 14, a light intensity of an illuminating part, the illuminating part forming a pair with a transmission intensity detecting part for a wet part, is measured by a direct light intensity detecting part 51. This structure allows for the following. In the case where a value of a film thickness is calculated from an obtained value of transmission intensity, a value of a film thickness in which a change in a ray of light of illumination is compensated can be measured by adding a value of a direct light intensity of an illumination part to the calculation. A coating amount can be measured without influence by a change in a ray of light even if the ray of light changes due to deterioration of the ray of light of illumination over a long period of time and a ray of light changes instantly due to power source noise. Light intensity of the illuminating part is directly measured by a direct light intensity detecting part 51 and thereby a coating amount can be measured without influence by a change in a ray of light of illumination light. A direct light intensity detecting part is arranged in the same side wherein a microcapsule coating substrate is arranged as standard, and directly detects light intensity of an illumination part.

In addition, in a method and a device for measuring a coating amount of a microcapsule related to the present invention, a method and a device for determining a coating amount, and a method for manufacturing a coating product, a coating amount can be measured more accurately by simultaneously measuring both a transmission light intensity of a wet part immediately after coating of a microcapsule and a transmission light intensity of a dry part in which a coated microcapsule coating liquid passes a dry unit 43 and becomes dry. Coating can be performed efficiently and manufacturing can be performed with very little waste by quickly finding errors without stopping the coating device. In this case, it is possible to use the coating device explained in FIG. 5.

FIG. 6 shows a relationship between a transmission light intensity obtained by measuring a wet part immediately after coating of a microcapsule and a transmission light intensity obtained by measuring a dry part in which a coated microcapsule coating liquid passes a dry unit 43 and becomes dry. In this case, there is also a correlative relationship between a transmission light intensity of a wet part and a transmission light intensity of a dry part shown in the graph of FIG. 7. Therefore, a transmission light intensity of a dry state is calculated from a transmission light intensity of a wet state, and a thickness of a microcapsule display layer 27 which is a coating amount of a dry state can be found from the calculated result.

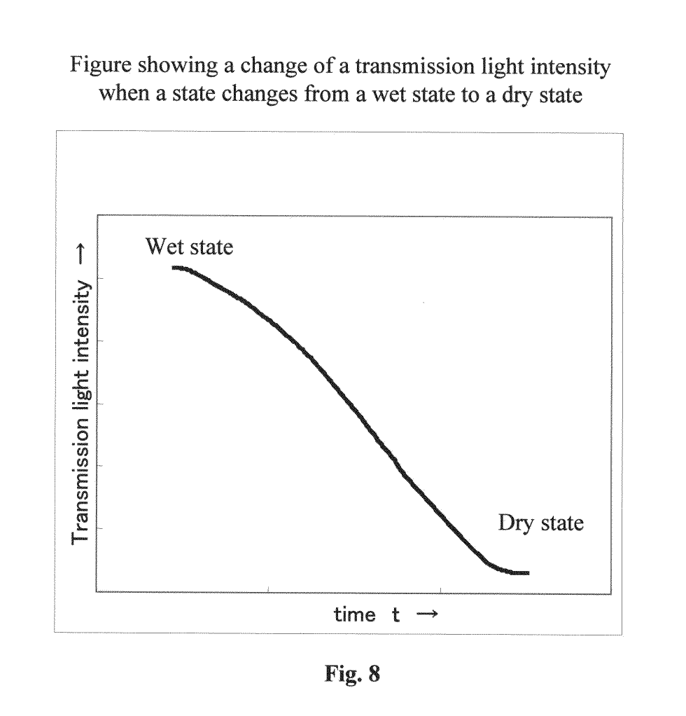

However, a wet state immediately after coating a microcapsule is between a state where a coated microcapsule coating liquid is dried and a dry state. As shown by the correlation of FIG. 8, when a wet state changes to a dry state, a transmission light intensity gradually decreases during the time elapsed from the wet state to the dry state. This result means that depending on which state immediately after coating is measured, a difference is produced in the thickness of the microcapsule display layer 27 which is a coating amount of a dry state, the coating amount being found as a result.

Then, in this device for measuring a coating amount, a thickness of a microcapsule display layer is found based on a transmission light intensity in a wet state immediately after coating, the thickness corresponding to a coating amount of a dry state. At this time, in a wet state and a dry state, the difference between a transmission light intensity detected by a light intensity detecting part for a wet part and a transmission light intensity detected by a light intensity detecting part for a dry part is found. A transmission light intensity of a dry part is calculated from a transmission light intensity of a wet part in view of this difference. The thickness of the microcapsule display layer which is a coating amount is found from the obtained transmission light intensity of a dry part.

In addition, in FIGS. 6 and 7, R² means a correlation coefficient. When R² is near 1, measurement data corresponds to an approximated curve. Therefore, a transmission light intensity of a wet part is in a correlation relationship with a transmission light intensity of a dry part, as shown in FIG. 7. Therefore, the thickness of a microcapsule display layer which is a coating amount of a dry state can be found from a transmission light intensity of a wet state by using the correlation relationship and a correlation relationship between a transmission light intensity of a dry state shown in FIG. 6 and a coating amount.

According to this embodiment, in a wet state immediately after coating and a dry state which is a standard for calculating a coating amount, respective intensities of transmission light are measured and a calculation is performed. Thereby, the thickness of the microcapsule display layer 27 in a dry state can be measured highly accurately even in a wet state immediately after coating.

What is claimed is:

1. A method for measuring a coating amount in the case where a microcapsule coating liquid is coated on a microcapsule coating substrate, the microcapsule coating liquid including a microcapsule in which a pigment is encapsulated and dispersed,
the method comprising steps of:
detecting a transmission light intensity in the case where the microcapsule coating substrate on which the microcapsule coating liquid is in a wet state is irradiated with illuminating light; and
calculating a thickness of a microcapsule display layer from the transmission light intensity, the microcapsule display layer being formed by drying the microcapsule coating liquid.

2. The method for measuring a coating amount according to claim 1, wherein the step of detecting the transmission light intensity includes individually detecting transmission light intensities in the case where three or more points including an end part and a center of the microcapsule coating substrate on which the microcapsule coating liquid is in a wet state are irradiated with illuminating light.

3. The method for measuring a coating amount according to claim 1, wherein, in the step of detecting the transmission light intensity, a direct light intensity of the illuminating light is detected by irradiating the microcapsule coating substrate with illuminating light, and a change of illuminating light is offset using values of the transmission light intensity detected and the direct light intensity.

4. A device for measuring a coating amount in the case where a microcapsule coating liquid is coated on a microcapsule coating substrate, the microcapsule coating liquid including a microcapsule in which a pigment is encapsulated and dispersed,
the device comprising:
a means for irradiating, with illuminating light, the microcapsule coating substrate on which the microcapsule coating liquid is in a wet state;
a means for detecting an intensity of transmission light which is obtained by illuminating light passing the microcapsule coating liquid in a wet state and the microcapsule coating substrate; and
a means for calculating a thickness of a microcapsule display layer based on the intensity of the transmission light which is detected by the means for detecting the intensity of the transmission light, the microcapsule display layer to be formed by drying the microcapsule coating liquid.

5. The device for measuring a coating amount according to claim 4, wherein the means for detecting the intensity of the transmission light is arranged at three or more positions including an end part and a center of the microcapsule coating substrate.

6. The device for measuring a coating amount according to claim 4, further comprising:
a means for detecting direct light which individually detects a direct light intensity of the illuminating light,
wherein, the means for calculating a thickness is configured to calculate a coating amount in a wet state based on the intensity of the transmission light detected by the means for detecting the intensity of transmission light, and is configured to calculate a coating amount of the microcapsule coating liquid by compensating for a change in the illuminating light based on values of the intensity of the transmission light which is detected and the direct light intensity.

7. A method for determining a coating-amount wherein a determination is made whether a thickness of a microcapsule display layer is within a predetermined range, the microcapsule display layer being in a dry state after drying a microcapsule coating liquid coated on a microcapsule coating substrate, the microcapsule coating liquid including microcapsule in which a pigment is encapsulated and dispersed, the method comprising steps of:
finding a correlative relationship between an intensity of transmission light of the microcapsule coating substrate on which the microcapsule coating liquid in a wet state is coated and an actual thickness of the microcapsule display layer formed by drying the microcapsule coating liquid;
determining an appropriate range of a transmission light intensity of the microcapsule coating substrate on which the microcapsule coating liquid in the wet state is coated, the appropriate range of the transmission light intensity corresponding to a predetermined appropriate range of a thickness of the microcapsule display layer, the appropriate range determined as a standard range from the correlative relationship;
detecting a transmission light intensity obtained by irradiating the microcapsule coating substrate in a wet state in which the microcapsule coating liquid is coated and is not dried with illuminating light; and
determining the thickness of the microcapsule display layer as being an appropriate value in the case where the transmission light intensity is within the standard range when the transmission light intensity is compared with the standard range, or a non-appropriate value in the case where the transmission light intensity is not within the standard range when the transmission light intensity is compared with the standard range.

8. The method for determining a coating amount according to claim 7, wherein the step of detecting the transmission light intensity includes individually detecting transmission light intensities in cases where three or more points including an end part and a center of the microcapsule coating substrate in which the microcapsule coating liquid is in a wet state are irradiated with illuminating light.

9. The method for determining a coating amount according to claim 7, wherein, a direct light intensity of the illuminating light is detected in the step of detecting a transmission intensity,
and
wherein, in the step of determining the thickness of the microcapsule display, a change in the illuminating light is offset using values of the transmission light intensity detected and the direct light intensity.

10. A device for determining a coating amount wherein a determination is made whether a thickness of a microcapsule display layer is within a predetermined rang, the microcapsule display layer being in a dry state after drying a microcapsule coating liquid coated on a microcapsule coating substrate, the microcapsule coating liquid including a microcapsule in which a pigment is encapsulated and dispersed,
the device comprising:
a means for storing that contains a correlative relationship between an intensity of transmission light of the microcapsule coating substrate on which the microcapsule coating liquid in a wet state is coated and an actual thickness of a microcapsule display layer which is formed by drying the microcapsule coating liquid which is coated, wherein the means for storing stores, as a standard range from the correlative relationship, an appropriate range of a transmission light intensity of the microcapsule coating substrate on which the microcapsule coating liquid in the wet state is coated, the appropriate range of the transmission light intensity corresponding to a predetermined appropriate range of a thickness of the microcapsule display layer;
a means for illuminating which irradiates, with illuminating light, the microcapsule coating substrate on which the microcapsule coating liquid is coated in a wet state;
a means for detecting a light intensity which detects an intensity of transmission light of the illuminating light of the means for illuminating, the illuminating light passing through the microcapsule coating substrate on which the microcapsule coating liquid is coated; and
a means for determining in which the intensity of the transmission light is compared with the standard range, and in which the thickness of the microcapsule display layer is determined as an appropriate value in the case where the intensity of the transmission light is within the standard range or a non-appropriate value in the case where the intensity of the transmission light is not within the standard range.

11. The device for determining a coating amount according to claim 10, wherein the means for detecting light intensity is arranged at three or more points including an end part and a center of the microcapsule coating substrate.

12. The device for determining a coating amount according to claim 10, further comprising:
a means for detecting direct light which individually detects a direct light intensity of the illuminating light,
wherein, in the means for determining, the determining includes offsetting a change in the illuminating light by using values of the intensity of the transmission light detected and the direct light intensity.

13. A device for coating,
the device comprising:
the device for measuring a coating amount according to claim 4,
wherein the microcapsule display layer is formed after coating and drying the microcapsule coating liquid to a dry state, the microcapsule coating liquid including a microcapsule in which a pigment is encapsulated and dispersed on the microcapsule coating substrate.

14. A device for coating,
the device comprising:
the device for determining a coating amount according to claim 10,
wherein the microcapsule display layer is formed after coating and drying the microcapsule coating liquid to a dry state, the microcapsule coating liquid including a microcapsule in which a pigment is encapsulated and dispersed on the microcapsule coating substrate.

15. A method for manufacturing a coating product,
the method comprising:
the method for measuring a coating amount according to claim 1,
wherein the microcapsule display layer is formed after coating and drying the microcapsule coating liquid to a dry state, the microcapsule coating liquid including a microcapsule in which a pigment is encapsulated and dispersed on the microcapsule coating substrate.

16. A method for manufacturing a coating product,
the method comprising:
the method for determining a coating amount according to claim 7,
wherein the microcapsule display layer is formed after coating and drying the microcapsule coating liquid to a dry state, the microcapsule coating liquid including a microcapsule in which a pigment is encapsulated and dispersed on the microcapsule coating substrate.
